(19) United States
(12) Patent Application Publication
(10) Pub. No.: US 2006/0191918 A1
(43) Pub. Date: Aug. 31, 2006

(54) Apparatus for heating a food product and heating devices and a feed assembly therefor

(75) Inventors: Ken K. Ashford, Wamberal, NSW (AU); David W McLean, East Corrimal NSW (AU); Stuart Brown, Green Point, NSW (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: IPV Pty Limited, ACN 097 167 863, West Gosford, New South Wales (AU)

(21) Appl. No.: 10/469,312

(22) PCT Filed: Mar. 1, 2002
(86) PCT No.: PCT/AU02/00228

§ 371 Date: Feb. 23, 2004

(30) Foreign Application Priority Data
Mar. 1, 2001 (AU) PR 3460

(51) Int. Cl. H05B 6/80

(52) U.S. Cl. 219/728

(57) ABSTRACT

A device (22) for heating a food product (P). The device (22) including an oven enclosure (52) at lest one magnetron for emitting microwave energy and a microwave energy focusing device (68, 70, 72) associated with at least one magnetron (56, 58, 60, 62, 64 and 66) and adapted to focus microwave energy towards the food product. The magnetron(s) is/are disposed external the enclosure (52) and the microwave energy focusing device(s) is/are disposed internal the enclosure (52). Also disclosed is a food product support device (116) of a substantially truncated conical external shape with a first larger base surface (118) adapted to be positioned adjacent the base of the oven enclosure and a second smaller supporting surface (120) adapted to support a food product (P) in a position vertically displaced from the base of the oven enclosure for heating and a sloping side surface (122) extending between the base and support surfaces. The food product (P) is able to exit the oven enclosure by sliding down the side surface (122) when pushed from the support surface towards (120) an opening in the oven enclosure. Also disclosed is a food product positioning and ejection device (138) adapted for reciprocal movement towards and away from an opening in the oven enclosure.

### FIELD OF THE INVENTION

The present invention relates to an apparatus for heating a food product and heating devices and a feed assembly therefor.

The apparatus, device and assembly have been primarily developed for use in a hot pie vending machine and will be described hereinafter with reference to that application. However, it will be appreciated that the apparatus, device and assembly are not limited to that particular application.

### BACKGROUND OF THE INVENTION

Food product vending machines are common at many public venues such as public transport stations, sporting fields, shopping centres and the like. The vending machines can be broadly categorised into three man types, namely: Refrigerating for products such as cool drinks and ice creams; Ambient for products such as sweets and crisps; and Heating for food products such as hot chips and prepared meals.

A disadvantage of existing heating food product vending machines is that they are slow in operation and produce a cooked product that is inferior to that cooked by conventional methods. For example, most heating food product vending machines rely on a conventional microwave type oven which results in soggy food and require the customer to purchase the food product from a vending machine and then place it in, and subsequently remove it from, a separate microwave oven.

### OBJECT OF THE INVENTION

It is an object of the present invention to substantially overcome or at least ameliorate the prior art deficiencies.

### SUMMARY OF THE INVENTION

In accordance with a first aspect of the invention there is provided a device for heating a food product, the device including:

an oven enclosure;

at least one magnetron for emitting microwave energy; and

a microwave energy focusing device associated with each magnetron and adapted to focus microwave energy towards the food product,

wherein the magnetron(s) is/are disposed external the enclosure and the microwave energy focusing-device(s) is/are disposed internal the enclosure.

The microwave energy focusing device(s) are preferably a horn with a first end adjacent the magnetron(s) and a second end directed towards the food product. In a preferred embodiment, the horn(s) has/have a substantially rectangular cross-section. In another embodiment, the horn(s) is/are substantially conical. In one form, the horns taper from a smaller first end to a larger second end. In another form, the first and second ends are the same size, which results in the horn(s) having the form of a parallel rectangular tube.

In one embodiment, the device includes a first (upper) magnetron and a second (lower) magnetron which are desirably substantially (vertically) aligned to face one another. The long axis of the horn of the first magnetron is preferably oriented with the short axis of the second magnetron. The device preferably includes a third (lower) magnetron which is desirably substantially (horizontally) aligned side-by-side with the second magnetron. The device preferably includes an infra red heater which is desirably substantially (vertically) aligned facing the third magnetron. The device preferably includes a fourth (upper) magnetron and a fifth (upper) magnetron either side of the infra red heater &hat are desirably disposed at an angle to facing the third magnetron. The device optionally includes a sixth (lower) magnetron which is desirably substantially (horizontally) aligned side-by-side with the third magnetron.

The infra red heater is desirably a single or a pair of halogen lamps.

The oven enclosure desirably includes an inlet door and, an outlet door, the doors being associated with interlocks such that the magnetrons/heater can not be energised whilst either door is open.

In another embodiment, the device includes a first (upper) magnetron and, desirably, second and third (side) magnetrons.

The oven enclosure desirably includes a door, the door being associated with an interlock such that the magnetron(s) can not be energised whilst the door is open.

The device desirably includes a conveyor in the oven enclosure between the inlet door and the outlet door. The conveyor is preferably controllable to convey a food product from the inlet door to a first heating position between the first and second magnetrons and then to a second heating position between the third, fourth and fifth magnetrons, and the heater and the fifth magnetron and then to the outlet door. The conveyor is optionally controllable to convey a food product from the second heating position to a third heating position above the sixth magnetron and then to the outlet door.

The conveyor is preferably also controllable to hold the food product stationary in the first heating position for a first predetermined period of time. The conveyor is preferably also controllable to oscillate the food product in the second heating position a predetermined distance for a second predetermined period of time. The conveyor is preferably optionally controllable to hold the food product stationary in the third heating position for a third predetermined period of time.

In accordance with a second aspect of the invention there is provided a food product feed assembly for a device for heating the food product, the assembly including:

an apparatus for storage of a plurality of food products, the apparatus having an outlet opening with a movable sealing device; and

a transfer means with a first receptacle adapted to receive the sealing device therein and a second receptacle adapted to receive one of the food products therein, the second receptacle having an outlet door adapted, upon opening, to release any food product in the second receptacle towards the device for heating the food product, the first receptacle being adjacent the outlet open when the transfer means is in a first position for receiving the sealing device and the second outlet being adjacent the outlet opening when the transfer means is in a second position for receiving a food product,

wherein the second receptacle outlet door is only openable when the transfer means is in the second position such that outlet opening is maintained substantially sealed by the first receptacle's sealing device when the transfer means is in the first position and is maintained substantially sealed by the second receptacle's outlet door when the transfer means is in the second position.

The transfer means is preferably adapted to receive the sealing device into the first receptacle in the first position, move to the second position and receive a food product in the second receptacle, then return to the second position for replacing the sealing device in the outlet and opening the outlet door to release the food product from the second receptacle.

The transfer means is preferably adapted to reciprocally slide between the first and second positions.

In an embodiment, the storage apparatus preferably includes at least one internal magazine adapted to receive a substantially vertical stack of food products therein, the bottom of the magazine having an open end alignable with the apparatus' outlet opening. The storage apparatus preferably includes a carousel with a multiplicity of said magazines therein. The carousel is desirably rotatable about a substantially vertical axis and adapted for indexed stopping in positions aligning the open end of each of said magazines with the apparatus' outlet opening.

In accordance with a third aspect of the invention, there is provided a device for heating a food product, the apparatus including:

a microwave oven enclosure;

a food product support device within the oven enclosure, the device being of a substantially truncated conical external shape with a first larger base surface adapted to be positioned adjacent the base of the oven enclosure and a second smaller supporting surface adapted to support a food product in a position vertically displaced from the base of the oven enclosure for heating and a sloping side surface extending between the base and support surfaces,

whereby the food product is able to exit the oven enclosure by sliding down the side surface when pushed from the support surface towards an opening in the oven enclosure.

The device preferably includes:

at least one magnetron for emitting microwave energy disposed external the enclosure; and

a microwave energy focusing device disposed the enclosure and associated with each magnetron and adapted to focus microwave energy towards the food product on the support surface.

The device preferably includes a hollow polyethylene base portion that includes the base and side surfaces and a teflon support portion that includes the support surface. The teflon support surface desirably includes a dipole antenna above which the food product is, in use, positioned, the antenna being adapted to focus the microwave energy towards the food product. The antenna is preferably in the form of a metal screw which is screwed into the side of the teflon support plate that is, in use, remote the food product.

In accordance with a fourth aspect of the invention, there is provided a device for heating a food product, the apparatus including:

an oven enclosure with an opening;

a food product positioning and ejection device adapted for reciprocal movement towards and away from the opening between retracted and an extended positions; and

a chute sloping downwardly into the enclosure through the opening, wherein when the device is adapted, when in the retracted position, to limit the movement of the food product into the enclosure by abutment with same further adapted to push the food product from the enclosure during movement towards the extended position.

The position and ejection device preferably also includes a food product head having a leading edge substantially complimentary to the food product and a sliding mechanism adapted to extend and retract the head. The sliding mechanism desirably includes a pair of guide rods and an expandable/retractable drive rod. The drive rod is preferably attached to a pneumatic cylinder or electrical solenoid.

The enclosure preferably includes a door over the opening and the chute is adapted to pivot downwardly to present its lower edge towards the opening when the door is open and to pivot upwardly to and away from the opening to allow the door to be opened and closed. Further, the enclosure desirably also includes a slide therein that is adapted to convey the food product from the chute to the retracted food product positioning and ejection device.

In an embodiment, the apparatus includes at least one internal magazine adapted to receive a substantially vertical stack of food products therein, the bottom of the magazine having an open end alignable with the chute. The apparatus preferably includes a carousel with a multiplicity of said magazines therein. The carousel is desirably rotatable about a substantially vertical axis and adapted for indexed shipping in positions aligning the open end of each of said magazines with the chute.

In accordance with a fifth aspect of the invention there is provided an apparatus for heating a food product, the apparatus including a device for heating a food product in accordance with the first aspect of the invention; a device for heating a food product in accordance with the third aspect of the invention and a device for heating a food product in accordance with the fourth aspect of the invention.

### BRIEF DESCRIPTION OF THE DRAWINGS

Preferred embodiments of the invention will now be described, by way of example only; with reference to the accompanying drawings, in which;

FIG. 1 is a schematic front view of an apparatus for heating a food product in accordance with a first embodiment of the invention;

FIG. 2 is a schematic top view of the apparatus shown in FIG. 1;

FIG. 3 is a schematic side view of the apparatus shown in FIG. 1;

FIG. 4 is a schematic side view of an embodiment of a transfer means used in a food product feed assembly used in the apparatus shown in FIG. 1;

FIG. 5 is a schematic top view of the transfer means shown in FIG. 4;

FIG. 6 is a schematic side view of a sealing device used with the transfer means shown in FIG. 4;

FIG. 7 is a schematic top view of the sealing device shown in FIG. 6;

FIGS. 8 to 11 are schematic cross sectional side views of an embodiment of a food product feed assembly utilising the transfer means shown in FIG. 4 and the sealing device shown in FIG. 6 in various progressive stages of operation;

FIG. 12 is a schematic side view of an embodiment of a device for heating a food product used in the apparatus shown in FIG. 1;

FIG. 13 is a schematic left hand end view of the device shown in FIG. 12;

FIG. 14 is a schematic right hand end view of the device shown in FIG. 12;

FIG. 15 is a schematic top view of the device shown in FIG. 12;

FIG. 16 is a schematic side view of a first embodiment of a microwave energy focusing device used in the food product heating device shown in FIG. 12;

FIG. 17 is a schematic top view of the focusing device shown in FIG. 16;

FIG. 18 is a schematic side view of a second embodiment of a microwave energy focusing device;

FIG. 19 is a schematic top view of the focusing device shown in FIG. 18.

FIG. 20 is a schematic front view of a second embodiment of a device for heating a food product used in a second embodiment of an apparatus for heating a food product according to the invention;

FIG. 21 is a schematic top view of the device shown in FIG. 20.

FIG. 22 is a schematic font view of the device shown in FIG. 20 with the oven door open during delivery of a pie;

FIG. 23 is a schematic front view of the device shown in FIG. 20 with the oven door closed during cooking of the pie;

FIG. 24 is a schematic front view of the device shown in FIG. 20 with the oven door open showing ejection of the pie; and

FIG. 25 is an enlarged cross sectional view of a top plate used in the device shown in FIG. 20.

### DETAILED DESCRIPTION OF THE PREFERRED EMBODIMENTS

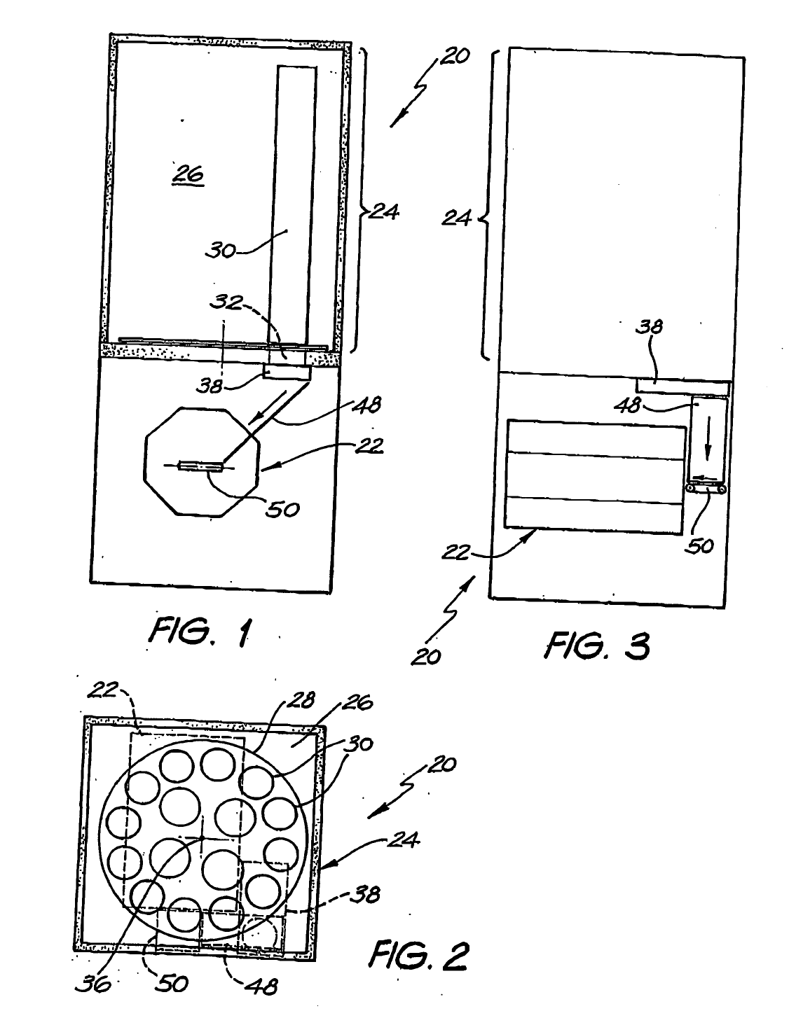

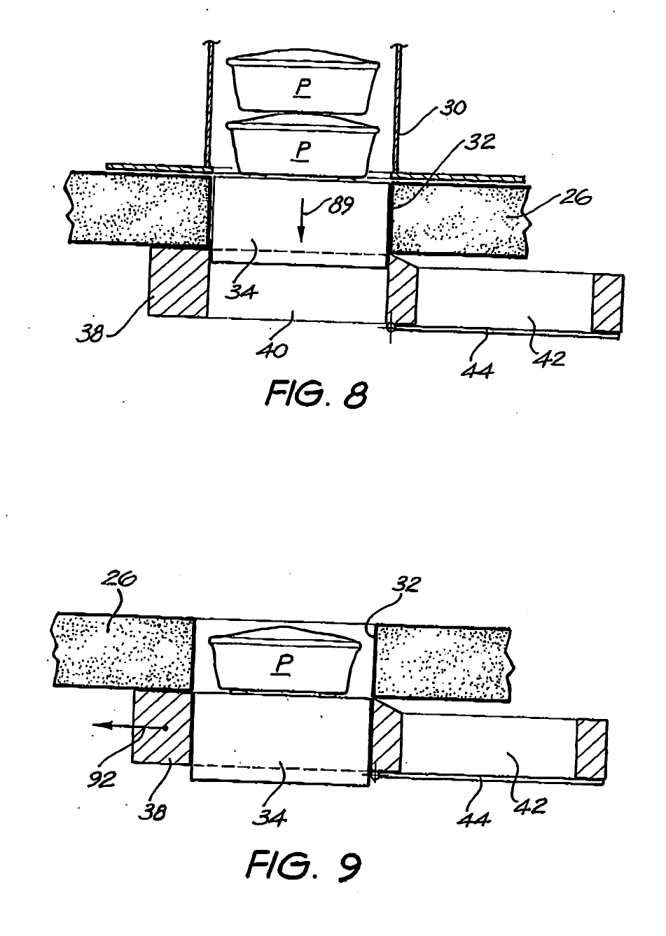

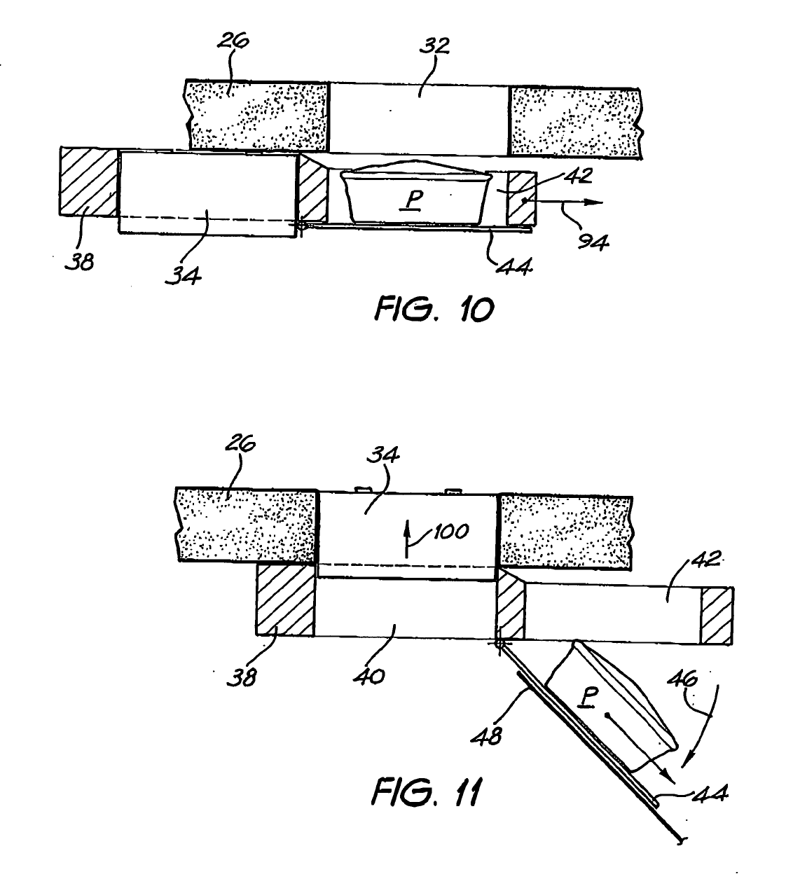

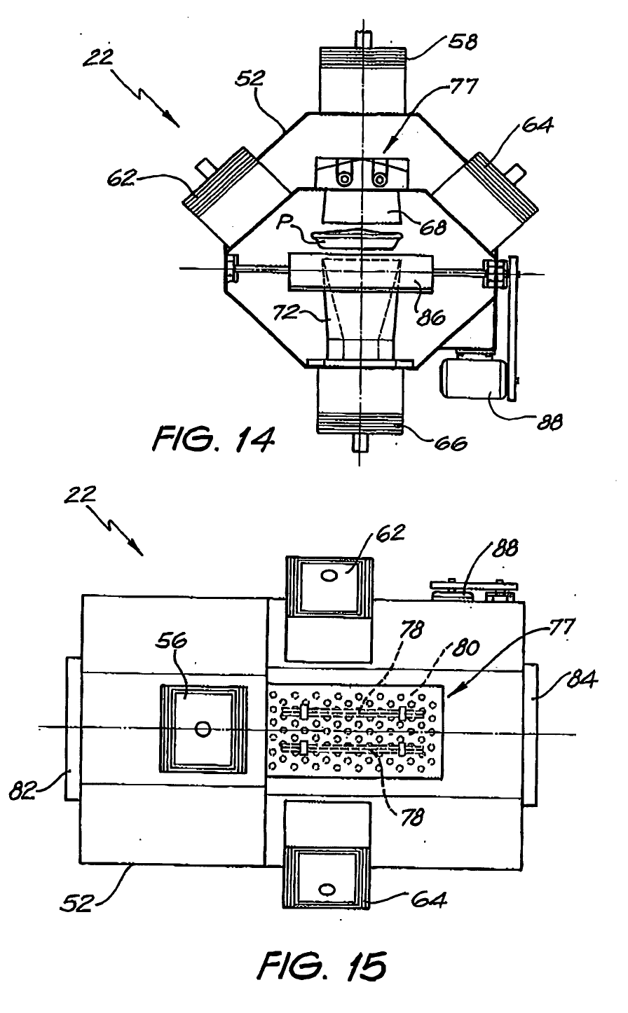

Referring firstly to FIGS. 1 to 3, there is shown an apparatus 20 for heating a food product, which in the preferred embodiment shown is a frozen pie P (see FIGS. 8 to 11 and FIGS. 13 to 14), according to a first embodiment of the invention. The apparatus 20 includes a device for heating the pie P, designated generally by the reference numeral 22, and a frozen pie feed assembly, designated generally by the reference numeral 24. The device 22 and assembly 24 will be described individually in more detail below.

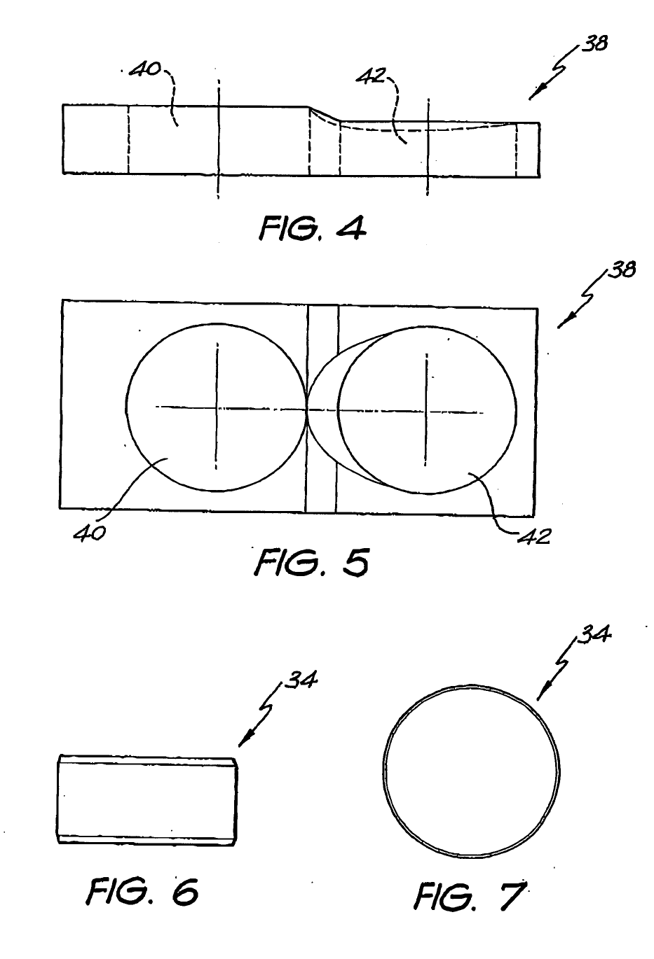

Referring to FIGS. 1 to 11, the feed assembly 24 basically comprises a sealable storage apparatus 26 which, in the preferred embodiment shown, is both refrigerated and insulated. The storage apparatus 26 includes a rotatable carousel 28 with an outer ring of twelve open-ended cylindrical magazines 30 therein that are each able to hold a stack of up to twenty-five frozen pies P. The magazines 30 have removable sliding closures (not shown) on each end to retain the pies P therein during transport, storage and installation and to prevent theft. The closures are removed during installation of the magazines 30 into the carousel 28.

The storage apparatus 26 has an outlet opening 32 at its lower end which is adapted to receive a moveable sealing device 34 (see FIG. 8) therein, as will be described in more detail below. The carousel 28 is rotatable about a vertical axis 36 and adapted for indexed stopping in twelve positions in which the lower open end of each of the magazines 30 is respectively aligned with the outlet opening 32 of the storage apparatus 26.

As best seen in FIGS. 4 and 5, the assembly 24 also includes a transfer means, in the form of block 38. The block 38 includes a first circular receptacle 40 adapted to receive the sealing device 34 therein and a second circular receptacle 42 adapted to receive one of the frozen pies P therein.

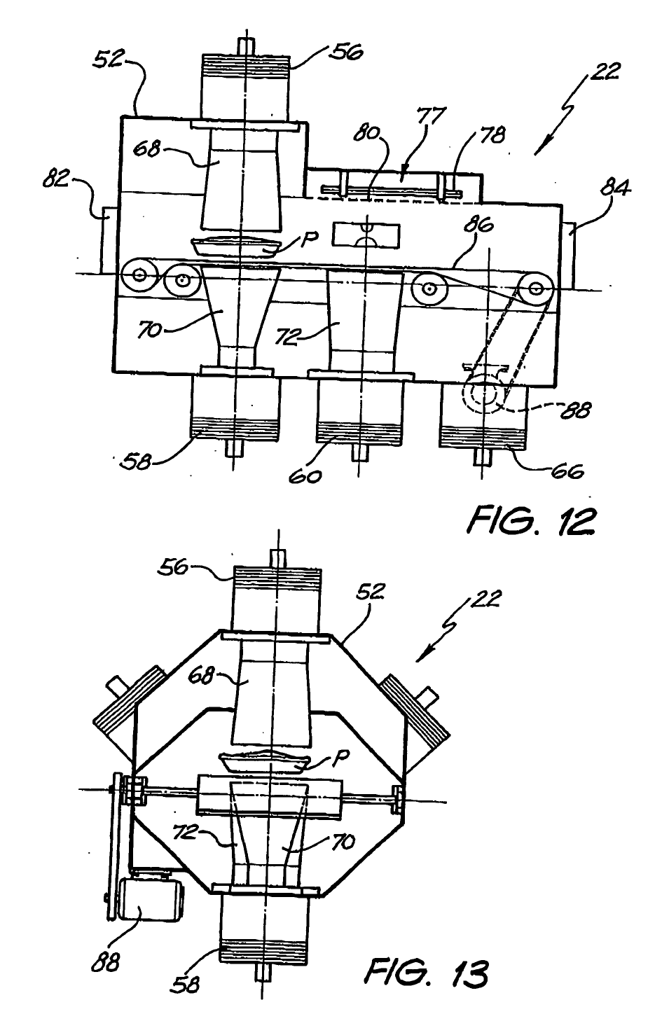

As best seen in FIGS. 8 to 11, the underside of the second receptacle 42 has an outlet door 44 which is pivotable in the direction of arrow 46 (see FIG. 11) to open or close the second receptacle 42. The block 38 reciprocally slides between a first position (see FIGS. 8 and 9) in which the first receptacle 40 is fully vertically aligned with the outlet opening 32 of the storage apparatus and a second position (see FIG. 10) in which the second receptacle 42 is substantially vertically aligned with the outlet opening 32. When the block is in the fist position the second receptacle 42 is substantially vertically aligned with a transfer chute 48 which leads to a transfer conveyor 50 (see FIG. 3) which itself leads to the food product heating device 22, which will now be described with reference to FIGS. 12 to 17.

The food product heating device 22 is basically comprised of a metal oven enclosure 52 which has first, second, third, fourth, fifth and optionally sixth microwave energy omitting magnetrons 56, 58, 60, 62, 64 and 66 respectively mounted thereon. The magnetrons, in the preferred embodiment shown, are of 1 to 2 KW capacity. The first, second and third magnetrons 56, 58 and 60 have their microwave energy directed by first embodiments of focusing horns 68, 70 and 72 respectively.

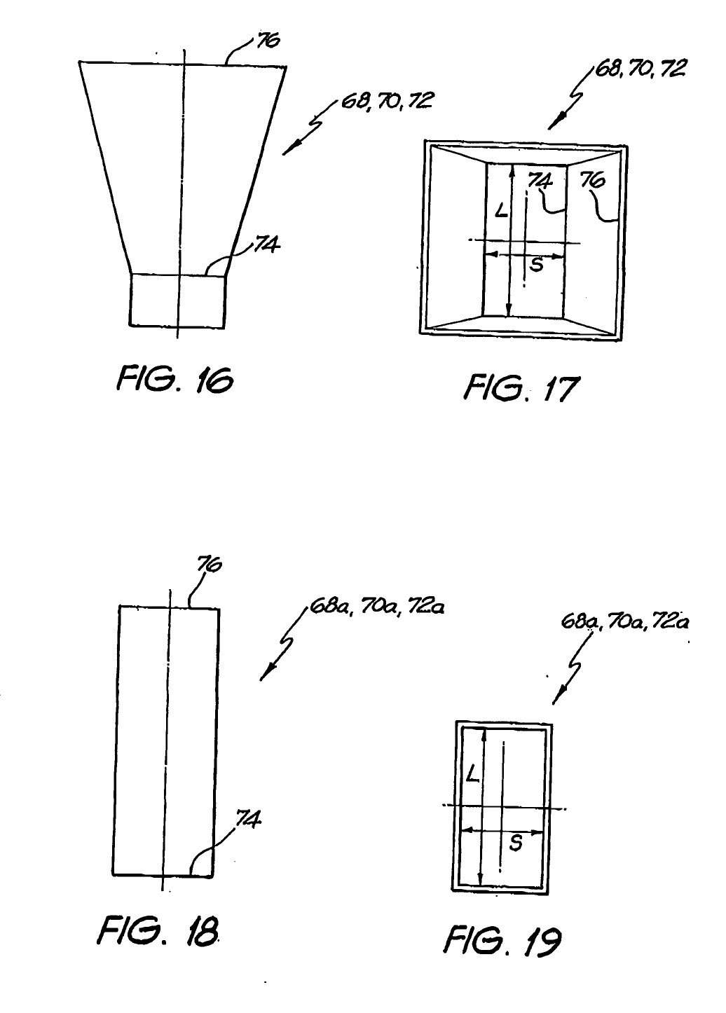

As best seen in FIGS. 16 and 17, the horns 68, 70 and 72 taper from a smaller end 74 adjacent the magnetron to a larger end 76 and have a rectangular cross section. The longer axis L of the first horn 68 is oriented with the shorter axis of the second horn 70.

FIGS. 18 and 19 show second embodiments of focusing horns 68a, 70a and 72a of parallel rectangular tube form that can alternatively be used with the food product heating device 22 of the apparatus 20.

Returning to FIGS. 12 to 15, the oven enclosure 52 also includes an infra red heater 77 in the form of a pair of halogen lamps 78 covered by a mesh screen 80, and an inlet and an outlet door 82 and 84 respectively. A controllable conveyor 86 driven by an electric drive motor 88 is provided between the inlet and outlet doors 82 and 84. As best shown in FIGS. 1 and 3, the transfer conveyor 50 leads to the oven inlet door 82.

In the preferred form shown, the first and second magnetrons 56 and 58 are substantially vertically aligned, the second, third and sixth magnetrons 58, 60 and 66 are substantially horizontally aligned and the fourth and fifth magnetrons 62 and 64 are angled with respect to the third magnetron 60 and are positioned either side of the infra red heater 77.

A control system (not shown) is also included in the apparatus 20, preferably a Programmable Logic Controller (PLC) which are well known in the art and will not be described in any further detail.

The operation of the food product heating apparatus 20 will now be described. Firstly, the carousel 28 is loaded with magazines 30 of frozen pies P, which are preferably at a temperature of −18° C. to −20° C. This reduces the required cooling capacity of the refrigeration device associated with the storage chamber 26 as it does not have to freeze/chill the food products, only maintain them at their pre-chilled delivery temperature. Different styles or flavours of pie P can be loaded into different magazines 30.

Secondly, a customer requests a particular style or flavour of pie P and places an appropriate payment into the apparatus 20. Various payment accepting mechanisms are also well known in the art and will not be described in any further detail. The control system then energises a stepper motor (not shown) to rotate the carousel 28 until the magazine 30 with the desired pie P therein is above the outlet 32, as is best seen in FIGS. 8 to 11. The control system then causes the sealing device 34 to be driven, preferably by a pneumatic cylinder (not shown), from within the outlet opening 32 to within the first receptacle 40. The sealing device 34 carries an adjacent pie P with it under the influence of gravity from the bottom of the magazine 30 into the outlet opening 32, as indicated by arrow 89. The control system then causes the block 38 to be driven, again preferably by a pneumatic cylinder (not shown), in the direction of arrow 92 from the first position (see FIGS. 8 and 9) to the second position (see FIG. 10) which results in the pie falling under the influence of gravity into the second receptacle 42. The outlet door 44 associated with the second opening 42 remains closed whilst the block 38 is in the second position.

The control system then causes the block 38 to be driven in the direction of arrow 94 back to the first position (see FIG. 11) and energises a further pneumatic cylinder (not shown) to cause the door 44 to pivot open, in the direction of arrow 46. This results in the pie P, falling onto the transfer chute 48 for travel, in the direction indicated by arrow 98, towards the transfer conveyor 50 (see FIG. 1). Simultaneously, the sealing device 34 is driven back into the outlet opening 32 to close same, as indicated by arrow 100. One reciprocal cycle of movement of the block 38 occurs within about 2 to 3 seconds.

Turning now to FIGS. 12 to 15, the inlet door 82 is opened and the conveyor 50 (see FIG. 1) is activated by the control system to drive the pie P into the oven enclosure 52 and onto the conveyor 86. The control system then actuates the drive motor 88 to move the conveyor 86 and bring the pie P to a first heat position (see FIG. 12) between the first and second magnetrons 56 and 58 the magnetrons 56 and 58 are then activated for between 10 to 30 seconds. The position of the pie P is preferably engaged by an electronic beam (not shown) communicating with the control system. Whilst in this position, the horns 68 and 70 (which are oriented at 90 degrees to one another) direct the microwave energy (which are thus also oriented at 90 degree to one another) emitted from the first and second magnetrons 56 and 58 into the frozen centre of the pie P to where maximum heating is required. The 90° orientation mentioned above advantageously avoids cross coupling of the energy of one magnetron to the other, as well as increasing the uniformity of heating of the central core of the pie P.

The pie P is then advanced to a second heating position between the third, fourth and fifth magnetrons 60, 62 and 64 and the infra red heater 77 where it oscillates fore and aft over an amplitude of 40 millimetres for a further 10 to 30 seconds. Whilst in this position, the third, fourth and fifth magnetrons 60, 62 and 64 continue to heat the remainder of the pie P, including the previously thawed centre, and the infra red heater 77 heats, browns and crisps the top layer of pastry.

The magnetrons/infra red heater are then de-energised and the pie P is advanced to and through the outlet door 84 for pick up by the customer. It should be noted that all the magnetrons and the infra red heater are interlocked with the inlet and outlet doors 82 and 84 and thus cannot be energised whilst either of the doors 82, 84 are open, either intentionally or inadvertently.

If further heating is required the control system can also be configured to place the pie above the sixth optional magnetron 66.

The embodiment of the invention described above has the following advantages over prior art devices. Firstly, the product feed assembly 24 is able to quickly deliver a selected pie from within the substantially sealed storage and refrigeration apparatus to the oven enclosure in 2 to 3 seconds. In this connection, it should be noted that the integrity of the seal of the refrigerated storage apparatus 26 is always maintained by either the sealing device when the block is in the first position or by the second receptacle outlet door when the block is in the second position, thereby ensuring minimal temperature losses. Also, if the invention is used to deliver a food product that is not refrigerated, then the same sealing arrangement advantageously maintains a substantially hermetic seal of the food storage chamber.

Secondly, the two stage heating process (ie. high intensity focused microwave energy and infra red heat) of the preferred embodiment is able to quickly thaw and heat a frozen food product whilst minimising degradation of the food product.

Thirdly, the total process from ordering a pie to receiving the heated pie takes only about 30 to 45 seconds and does not require any assistance from the customer.

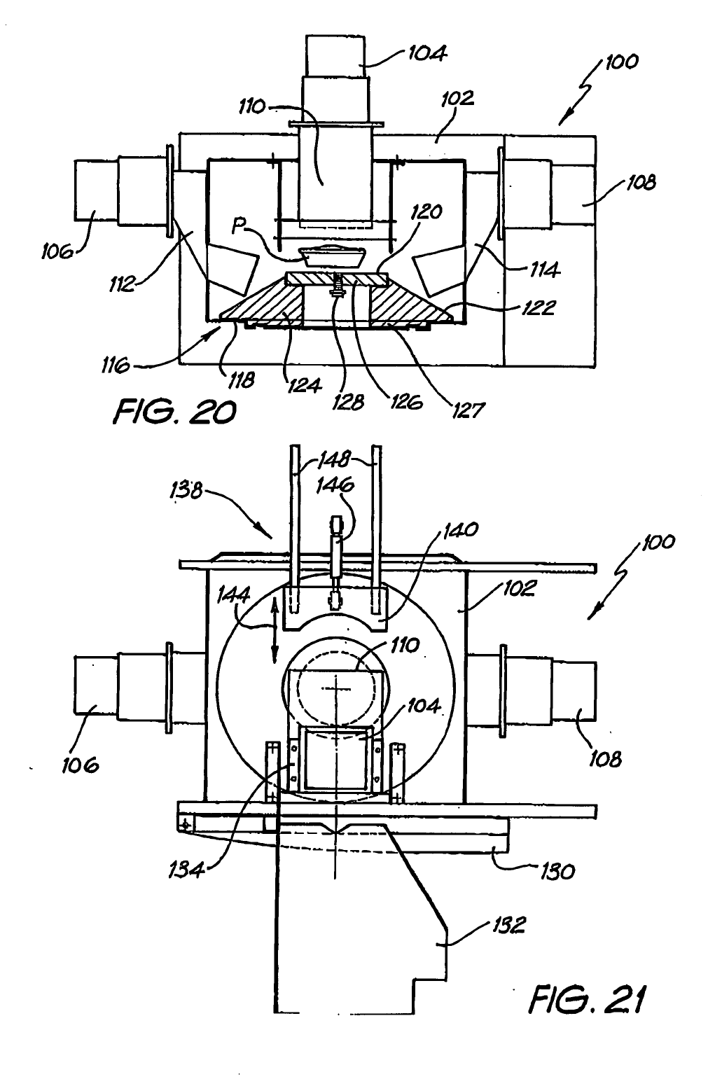

FIGS. 20 to 24 show a second embodiment of a device, designated generally by the reference numeral 100, for heating a pie P. The device 100 includes an oven enclosure 102 that has one (1000 Watt) upper magnetron 104 and two (800 Watt) side magnetrons 106 and 108 respectively, which are located externally of the enclosure 102. Each of the magnetrons 104, 106 and 108 have an associated focusing horn. 110, 112 and 114 respectively, which are located within the oven enclosure 102. The horns 110, 112 and 114 taper from a smaller end adjacent to their respective magnetron to a larger end inside the enclosure 102 focus the microwave energy from the magnetrons 104, 106 and 108 towards the pie P which is, during heating, positioned atop a food product support device, designated generally by the reference numeral 116, which will be described in more detail below.

The oven enclosure 102 is similar to known household microwave ovens, except for the addition of the magnetrons 104 and 106 and the horns 110, 112 and 114 previously described.

The support device 116 has a substantially truncated conical external shape with a large annular base surface 118, a smaller circular support 120 and all outwardly downwardly sloping side surface 122 therebetween. The support device 116 is formed from two components, namely a polyethylene hollow base portion 124 and a teflon top plate 126. The base portion 124 sits on, and in use in rotated by, the oven's internal electric motor driven base carousel 127, which are well known. The top plate 126 has a short dipole antenna, in the form of a steel screw 128, screwed into it. The screw 128 serves to assist in focusing the microwave energy emitted from the focusing horns 110, 112 and 114, which are themselves directed towards the (elevated) heating position of the pie P when atop the support device 116. As best shown in FIG. 25, the top plate 126 has a central rebate 127 to assist locating the pie P thereon as the pie P slides into the oven enclosure 102. The diameter of the rebate 127 matches the size of the pie base.

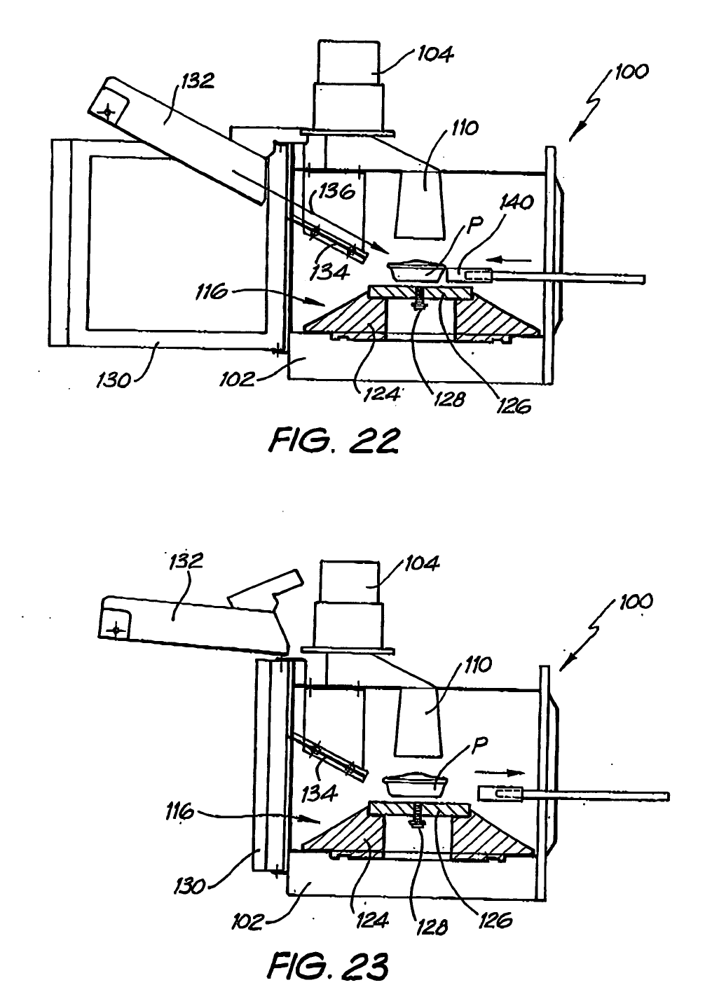

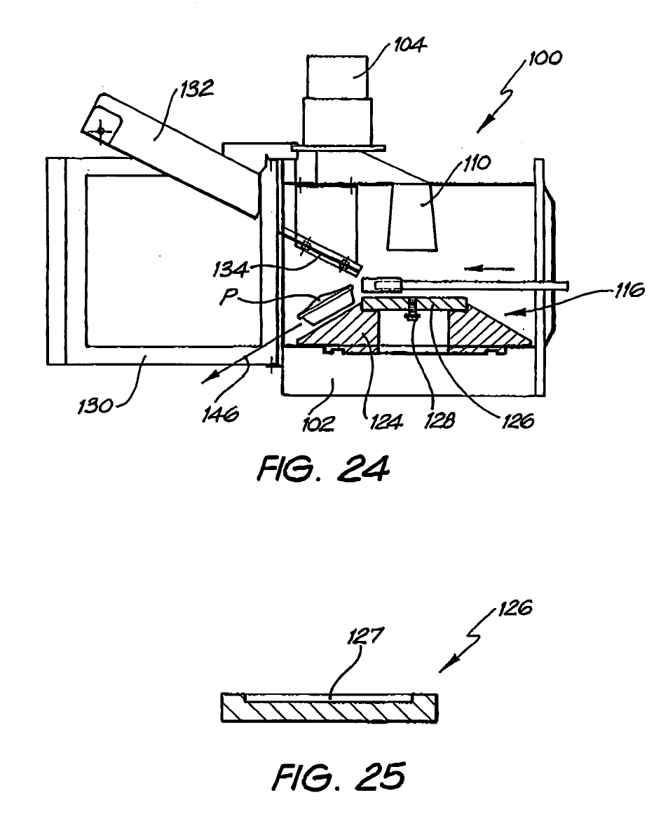

The front of the enclosure 102 has a door 130 adapted to be opened and closed under control from the previously described PLC. External the enclosure 102 is a pivotally mounted chute 132 having a distal end that rests on the top edge of the door 130. The chute 132 pivots to a raised position (see FIG. 23) by being pushed upwards by the door 130 as the door 130 is closed. When the door 130 is opened, the chute 132 pivots, under the influence of gravity, to a lower position (see FIGS. 22 and 24), where the lower most edge of the chute 132 is directed into the oven enclosure 102. In the lower position the lower edge of the chute 132 is substantially adjacent to the upper edge of a slide 134 suspended within the enclosure 102. As is shown by arrow 136, the lowered chute 132 and slide 134 co-operate to provide a path for a pie P down the chute 132, across the slide 134 and onto the teflon top plate 126. The chute 132 is fed from the previously described carousel 28.

A food product positioning and ejection device, designated generally by the reference numeral 138, also extends into the oven enclosure 102. The device 138 includes a polyethylene positioning head 140 whose leading edge 142 is complimentary to that of the pie P. The head 140 is able to be extended and retracted in the direction of double headed arrow 144 by expandable/retractable pneumatic cylinder 146. The device 138 also includes guide rods 148 to maintain the head 140 in the orientation shown.

The operation of the device 100 will now be described. Firstly, a modified form (not shown) of the previously described carousel 28 is loaded with frozen pies P. The modified carousel uses fixed guide rods in place of the removable magazines 30. Secondly, a customer requests a particular style or flavour of pie P and places an appropriate payment into the apparatus, also as previously described. The control system then energises a ratchet type index arm (not shown), operated by a pneumatic cylinder (not shown), to rotate the carousel 28 until the desired pie P is above the chute 132, again as previously described. The control system then causes a device (not shown) similar to the moveable sealing device 34 to be driven away from the cylinder outlet opening 32 so that an adjacent pie P falls, under the influence of gravity, from the bottom of the cylinder 30 and on to the chute 132.

In preparation for the pie P entering the chute 132, the door 130 is opened, which allows the chute 132 to pivot downwardly into the lowered position shown in FIG. 22. The head 140 is then extended to the position shown in FIG. 22. The pie P then slides down the chute 132, across the slide 134 and onto the top plate 126, all in the direction of arrow 136. The movement of the pie P is stopped by its abutment with the surface 142 of the head 140, thereby positioning the pie P generally in the centre of the top plate 126 adjacent the rebate 127 and, importantly, above the screw 128 and between the horns 110, 112 and 114.

The door 130 is then closed which allows the chute 132 to pivot upwardly to the raised position shown in FIG. 23. During this time the head 140 is retracted to the position shown in FIG. 23 so that all available microwave energy can be received by the pie P. The magnetrons 104, 106 and 108 are then energised and the pie P is then defrosted and heated. The antenna (screw 128) helps to further focus and concentrate the microwave energy in the base of the pie P.

When the heating is complete, the door 130 is open and the head 140 is extended towards the pie P and across the top plate 126 so as to push the cooked pie P from the plate onto the sloping side wall 122. The pie P slides down the wall 122 into a customer delivery chute, in the direction of arrow 146. The head is then retracted to the position shown in FIG. 22, ready for receipt of another pie from the chute 132 and slide 134.

The second embodiment of the invention described above possesses the advantages of the first described embodiment. The second embodiment also has the advantage of lower construction costs due to the use of a modified form of a readily available domestic microwave oven enclosure 102 and the simplified positioning and ejection device 138. Another advantage is the focusing and concentrating of the microwave energy in the base of the pie P caused by the antenna (screw 128).

Although the invention has been described with reference to preferred embodiments, it will be appreciated by those skilled in the art that the invention may be embodied in many other forms. As examples, the invention is also able to be used with other frozen and non-frozen food products tat are best served with a crisped or browned upper surface such as pizzas, pastries, sausage rolls, calzones and turnovers. Also, more than one type of food product may be provided in a single apparatus. For example, with reference to FIG. 2, pies can be provided in the outer row of small cylindrical chambers and pizzas may be provided in the inner row of larger cylindrical chambers. The inner row of magazines being associated with a second feed assembly (not shown) similar to the feed assembly described above.

1. An device for heating a food product, the device including:
an oven enclosure;
at least one magnetron for emitting microwave energy; and
a microwave energy focusing device associated with each magnetron and adapted to focus microwave energy towards the food product,
wherein the magnetron(s) is/are disposed external the enclosure and the microwave energy focusing device(s) is/are disposed internal the enclosure.

2. The device as claimed in claim 1, wherein the microwave energy focusing device(s) are a horn with a first end adjacent the magnetron(s) and a second end directed towards the food product.

3. The device as claimed in claim 2, wherein the horn(s) has/have a rectangular cross-section or is/are substantially conical.

4. The device as claimed in claim 2, wherein the horn(s) taper from a smaller first end to a larger second end.

5. The device as claimed in claim 1, wherein the device includes a first (upper) magnetron.

6. The device as claimed in claim 5, wherein the device includes second and third (side) magnetrons.

7. The device as claimed in claim 1, wherein the oven enclosure includes a door, the door being associated with an interlock such that the magnetron(s) can not be energised whilst the door is open.

8. An device for heating a food product, the apparatus including:
a microwave oven enclosure;
a food product support device within the oven enclosure, the device being of a substantially truncated conical external shape with a first larger base surface adapted to be positioned adjacent the base of the oven enclosure and a second smaller supporting surface adapted to support a food product in a position vertically displaced from the base of the oven enclosure for heating and a sloping side surface extending between the base and support surfaces,
whereby the food product is able to exit the oven enclosure by sliding down the side surface when pushed from the support surface towards an opening in the oven enclosure.

9. The device as claimed in claim 8, wherein the device includes:
at least one magnetron for emitting microwave energy disposed external the enclosure; and
a microwave energy focusing device disposed internal the enclosure and associated with each magnetron and adapted to focus microwave energy towards the support surface.

10. The device as claimed in claim 8, wherein the support device includes a hollow polyethylene base portion that includes the base and side surfaces and a Teflon support portion that includes the support surface.

11. The device as claimed in claim 10, wherein the Teflon support surface includes a dipole antenna adapted above which the food product is, in use, positioned, the antenna being adapted to focus the microwave energy towards the food product.

12. The device as claimed in claim 11, wherein the antenna is a metal screw which is screwed into the surface of the Teflon support plate that is, in use, remote the food product.

13. An device for heating a food product, the device including:
an oven enclosure with an opening;
a food product positioning and ejection device adapted for reciprocal movement towards and away from the opening between retracted and an extended positions; and
a chute sloping downwardly into the enclosure through the opening, wherein when the device is adapted, when in the retracted position, to limit the movement of the food product into the enclosure by abutment with same further adapted to push the food product from the enclosure during movement towards the extended position.

14. The device as claimed in claim 13, wherein the positioning and ejection device includes a food product head having a leading edge substantially complimentary to the food product and a sliding mechanism adapted to extend and retract the head.

15. The device as claimed in claim 14, wherein the sliding mechanism includes a pair of guide rods and an expandable/retractable drive rod.

16. The device as claimed in claim 15, wherein the drive rod is attached to a pneumatic cylinder or electrical solenoid.

17. The device as claimed in claim 13, wherein the enclosure includes a door over the opening and the chute is adapted to pivot downwardly to present its lower edge towards the opening when the door is open and to pivot upwardly and away from the opening to allow the door to be opened and closed.

18. The device as claimed in claim 13, wherein the enclosure includes a slide therein that is adapted to convey the food product from the chute to the retracted food product positioning and ejection device.

19. The device as claimed in claim 13, wherein the device includes at least one internal magazine adapted to receive a substantially vertical stack of food products therein, the bottom of the magazine having an open end alignable with the chute.

20. The device as claimed in claim 19, wherein the device includes a carousel with a multiplicity of said magazines therein.

21. The device as claimed in claim 19, wherein the carousel is rotatable about a substantially vertical axis and adapted for indexed stopping in positions aligning the open end of each of said magazines with the chute.

22. An apparatus for heating a food product, the apparatus including: a device as claimed in claim 1.
